(19) United States
(12) Patent Application Publication
(10) Pub. No.: US 2006/0215410 A1
(43) Pub. Date: Sep. 28, 2006

(54) Floodlight-supported decorative body and mount system

(76) Inventors: Jonny Mitchell, Farmington, NM (US); Bonnie Mitchell, Farmington, NM (US)

Correspondence Address: LITMAN LAW OFFICES, LTD, PO BOX 15035, CRYSTAL CITY STATION, ARLINGTON, VA, 22215, US

(21) Appl. No.: 11/385,996

(22) Filed: Mar. 22, 2006

Related U.S. Application Data
(60) Provisional application No. 60/663,733, filed on Mar. 22, 2005.

(51) Int. Cl. F21S 13/10

(52) U.S. Cl. 362/363

(57) ABSTRACT

The floodlight-supported decorative body and mount system includes a decorative body having a support sleeve with a sleeve angle adjustment portion. The mount includes a tubular inner support sleeve-and-hood member having an upper cylindrical portion forming an inner support sleeve, a conical hood portion, and a lower neck. The inner support sleeve slidingly engages, and is vertically adjustable within, the body support sleeve. The conical hood portion defines a hood lamp opening for insertion of a floodlight lamp and, further, for ventilation. The neck engages and attaches to the lamp housing of a floodlight. The decorative body is translucent to display the features of the decorative body when the floodlight is shining. The system may include a housing collar formed from flexible material positioned between the floodlight housing and the neck of the inner sleeve and support.

### CROSS-REFERENCE TO RELATED APPLICATION

This application claims the benefit of U.S. Provisional Patent Application Ser. No. 60/663,733, filed Mar. 22, 2005.

### BACKGROUND OF THE INVENTION

1. Field of the Invention

The present invention relates to lighted decorative items. More particularly, the present invention relates to a floodlight-supported decorative body and mount system including a translucent, decorative body having a figure related to a holiday or other event, and having a support for mounting on a standard outdoor floodlight.

2. Description of the Related Art

The use of lighted outdoor figures during holidays and the like is widespread. This is particularly true of the Christmas season, for example, when Santa Claus, elves, reindeer, and sleighs are often presented at night in the form of lighted characters. Another common example of a holiday theme lighted decoration would be a menorah. In other celebrations, such as Halloween, common use is made of lighted jack o'lanterns. This practice may be costly, time consuming, and often dangerous to provide the electric lines, connections and setup required for these displays.

It would be desirable to provide translucent, holiday, lighted figures for outdoor display, which take advantage of existing lighting, such as existing floodlights mounted in a yard or on the side of houses or other structures. It would also be desirable if such figures and their support assemblies were easy to install and remove.

Thus, a floodlight-supported decorative body and mount system solving the aforementioned problems is desired.

### SUMMARY OF THE INVENTION

The floodlight-supported decorative body and mount system includes a translucent decorative body having a support sleeve separated therefrom by a sleeve angle adjustment portion. The sleeve angle adjustment portion allows for user-selectable angular adjustment, and may take the form of a bellows-type sidewall. The mount system includes a generally tubular inner support sleeve-and-hood member having an upper cylindrical portion, which forms an inner support sleeve, a conical hood portion, and a neck. The inner support sleeve engages, and is vertically adjustable within, the support sleeve depending from the decorative body by means of adjustably engaging threads. The conical hood portion defines a hood lamp opening for insertion of a floodlight lamp. The neck engages or attaches to the lamp housing of a floodlight.

The decorative body is translucent to display the features of the decorative body when the floodlight is shining at night. The floodlight-supported system may include a housing collar formed from flexible material and positionable between the floodlight housing and the lower cylindrical portion of the inner sleeve and support.

The decorative body may be a full body figurine for mounting on a stake-mounted floodlight to present a 360° image of the ornamental figure. The decorative body may, alternatively, be a shell or demi-figurine, presenting only a 180° frontal image of the ornamental figure, or less than 180°, permitting the decorative body to be attached to a floodlight mounted on the lower wall of a house or other structure.

These and other features of the present invention will become readily apparent upon further review of the following specification and drawings.

### BRIEF DESCRIPTION OF THE DRAWINGS

FIG. 1 is an environmental, perspective view of a floodlight-supported decorative body and mount system according to the present invention mounted in the ground.

FIG. 2 is an environmental, perspective view of a floodlight-supported decorative body and mount system according to the present invention mounted on a floodlight on a roof soffit.

FIG. 3 is an exploded, partial perspective view of the decorative body and mount system of FIG. 1.

FIG. 4 is a detail perspective view of the inner support sleeve-and-hood of the mount system of FIG. 3.

FIG. 5A is a front perspective view of the inner support sleeve-and-hood of FIG. 4, showing the conical hood lamp opening.

FIG. 5B is a side perspective view of the inner support sleeve-and-hood of FIG. 5A.

FIG. 5C is a rear perspective view of the inner support sleeve-and-hood of FIG. 5A.

FIG. 6 is an environmental side view of an alternative embodiment of the floodlight-supported decorative body and mount system according to the present invention.

FIG. 7 is a perspective view of an alternative embodiment of the inner support sleeve-and-hood of the mount system of FIG. 3.

Similar reference characters denote corresponding features consistently throughout the attached drawings.

### DETAILED DESCRIPTION OF THE PREFERRED EMBODIMENT

The present invention is a floodlight-supported decorative body and mount system for mounting over an exterior floodlight, primarily for holiday decoration or other display purposes.

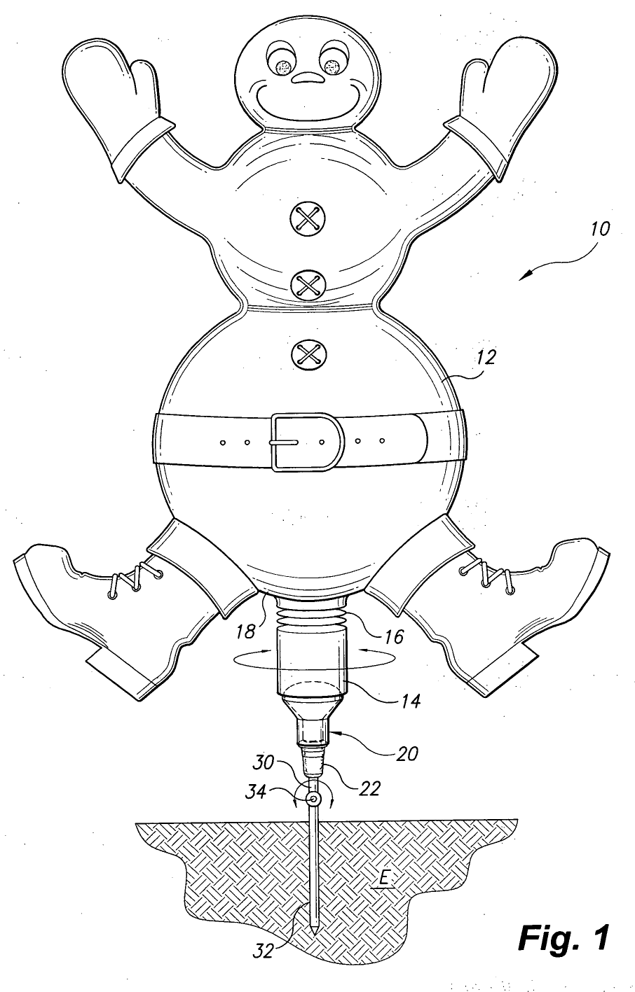

Referring to FIG. 1, there is shown a front elevation view of a floodlight-supported decorative body and mount system of the present invention, collectively referred to by the reference number 10 in the drawings and as “the system” in the text. The system 10 includes an erect figurine or decorative body 12 formed from hollow translucent material, such as plastic, which is formed to simulate an appropriate figure, such as a snowman, having appropriately shaped and colored features for a holiday or decorative display. Other figures, such as Santa Claus, an elf, the Easter Bunny, Uncle Sam, a flag, a menorah or the like may be similarly displayed consistent with a holiday or event.

Decorative body 12 includes a cylindrical support sleeve 14 integral with, and extending outwardly from, the decorative body 12, and may be molded from the same plastic material as the body. A sleeve angle adjustment portion 16 includes a series of circumferential ridges or pleats forming a bellows having sufficient flexibility to allow adjustment of the decorative body 12 to an erect position, even if the floodlight is not mounted precisely vertical. A generally tubular inner support sleeve-and-hood 20 fastens over the housing 22 of the floodlight, supporting the decorative body 12 by engagement with cylindrical support sleeve 14, allowing rotating adjustment thereof.

As shown in this exemplary environment, the floodlight housing 22 is supported on a floodlight mount 30, which is planted in the earth E by stake 32 and rotated to a desired angle of inclination by floodlight angle joint 34 (the electrical line is not shown). In this exemplary installation, the decorative body 12 may be a full body figurine of typical dimensions, being fully enclosed 360° to present both the front and back image of the decorative character. The decorative body 12 may alternatively be formed as a demi-figurine or shell, presenting only a 180° image, being open at the back in the manner of a mask. When the decorative body 12 is only a 180° shell, the body 12 may only be approximately two to three inches in thickness, for example, allowing the body to be mounted to a floodlight attached to the lower portion of the wall of a house or other structure. The sleeve angle adjustment portion 16 allows the decorative body 12 to be bent to an erect position from the typically inclined installation of a wall-mounted floodlight. Also, in this configuration, decorative body 12 will be less vulnerable to wind damage.

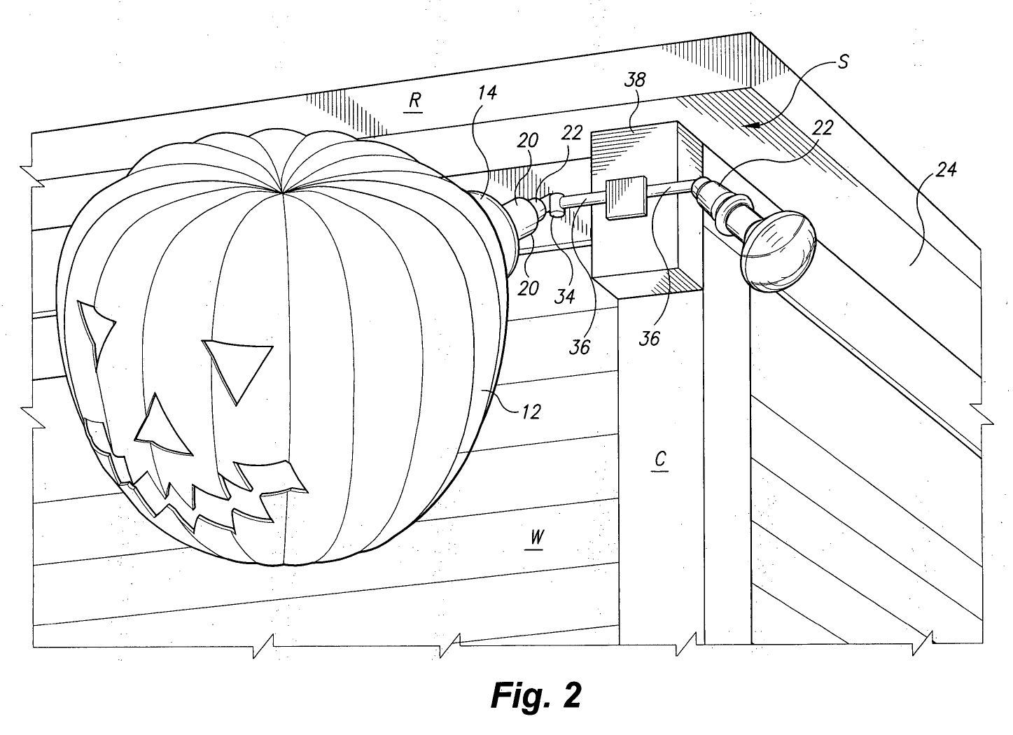

Referring to FIG. 2, there is shown another installation of a decorative body 12 made of translucent plastic, in this example depicting a Jack o'Lantern. The lantern is installed at the soffit S of the roof R at the corner C of wall W. Cylindrical support sleeve 14 extends from the decorative body 12, and inner support sleeve-and-hood member 20 is attached around lamp housing 22. The floodlight angle joint 34 allows angular adjustment of the floodlight housing 22 and attaches the floodlight to overhead electrical mount box 38 by means of conduits 36. An undecorated floodlight lamp 24 is shown within its housing 22 for lighting on the other wall of the house or other structure in a typical installation.

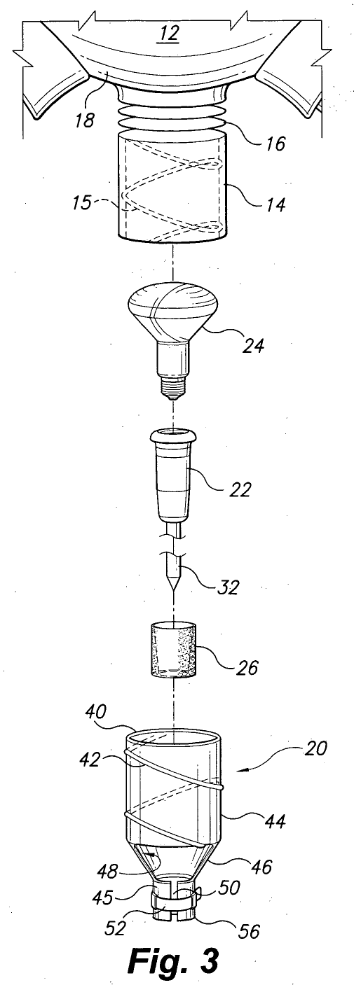

Referring to FIG. 3, there is shown an exploded view of the installation of FIG. 1, wherein cylindrical support sleeve 14 is connected to decorative body 12 by sleeve angle adjustment portion 16 at body support connection 18. In this embodiment, sleeve 14 has an inner thread 15 to receive the corresponding thread 42 of the upper cylindrical portion 44 of inner support sleeve-and-hood member 20. Lamp 24 fits within floodlight housing 22, which, in turn, is attached to stake 32 for support. An angle joint 34 may be added as desired (as shown in FIG. 1). A housing collar 26 of relatively soft, flexible material, such as rubber, acts as a gasket between housing 22 and neck 45 of inner support sleeve-and-hood 20.

Inner support sleeve-and-hood 20 is generally tubular, having an upper rim 40 and a height adjustment thread 42 formed on the outer surface of cylindrical portion 44. Cylindrical portion 44 extends downward to a conical hood portion 46, defining a lamp opening 48 for inserting lamp 24 when the decorative body support sleeve 14 is positioned over conical hood portion 46, and further provides for heat dissipation and ventilation.

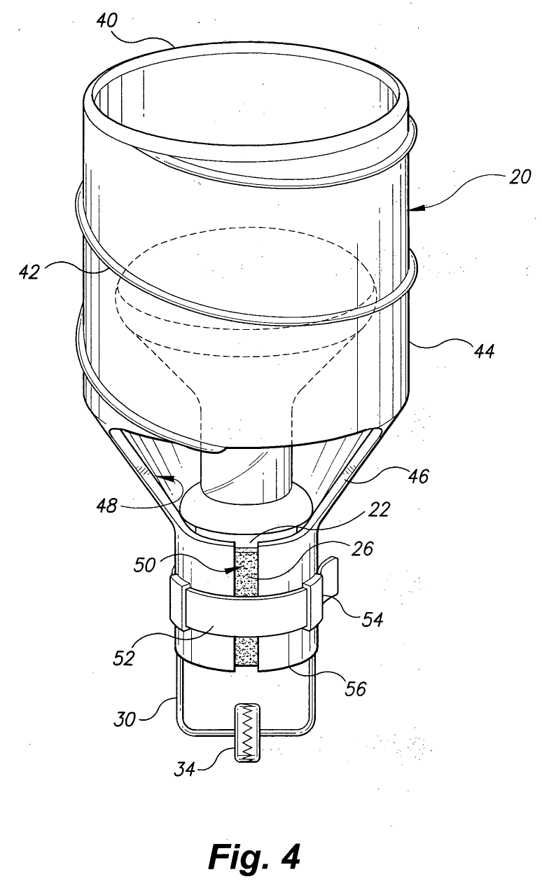

Conical hood portion 46 extends downward to neck 45, which wraps around floodlight housing 22 and is clamped thereagainst by circumferential band 52 having a tightening buckle 54 (best shown in FIG. 4). Neck 45 extends to a lower lip end 56 and preferably has a vertical adjustment gap 50 formed therein, extending upward into conical hood lamp opening 48 for clamping adjustment of cylindrical portion 44 to the body of floodlight housing 22. Housing collar 26 may be removed from the support structure if neck 45 is sufficiently flexible to allow it to clamp tightly against the wall of lamp housing 22.

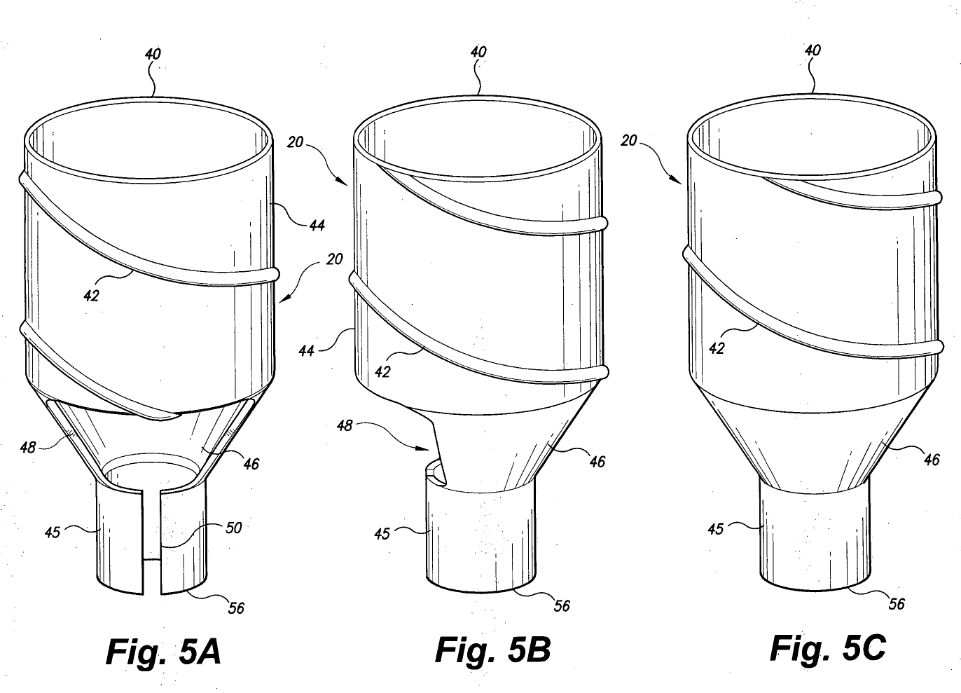

Referring to FIGS. 5A, 5B, and 5C there are shown frontal, side, and rear views, respectively, of the inner support sleeve-and-hood 20 as described above. If the support sleeve-and-hood 20 is formed from a material having sufficient resilience, the neck 45 may snap over the floodlight housing 22 and hold stably thereagainst without the adjustment band 52 or buckle 54 during installation. The support sleeve-and-hood 20 may be made of sheet metal or molded plastic of an appropriate type, as desired. The height adjustment threads 15 and 42 allow the decorative body to be adjusted upward or downward relative to the floodlight lamp housing 22, as desired.

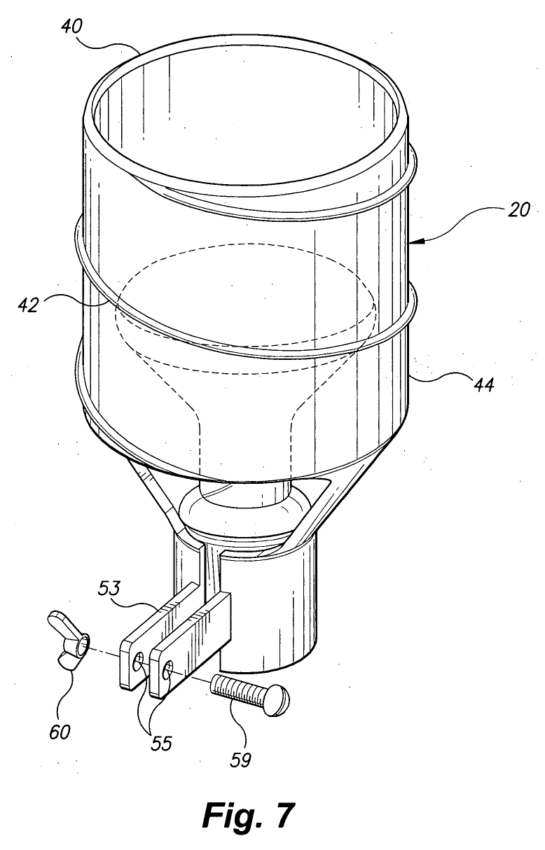

Alternatively, as shown in FIG. 7, rather than the combination of band 52 and buckle 54, a pair of tabs 53 may be provided. Each tab 53 extends outwardly from one of the open edges adjacent collar 26, and each tab 53 includes an opening for insertion of a screw 59, which is secured by a wing nut 60 that can be finger-tightened to adjustably join the tabs 53 to one another.

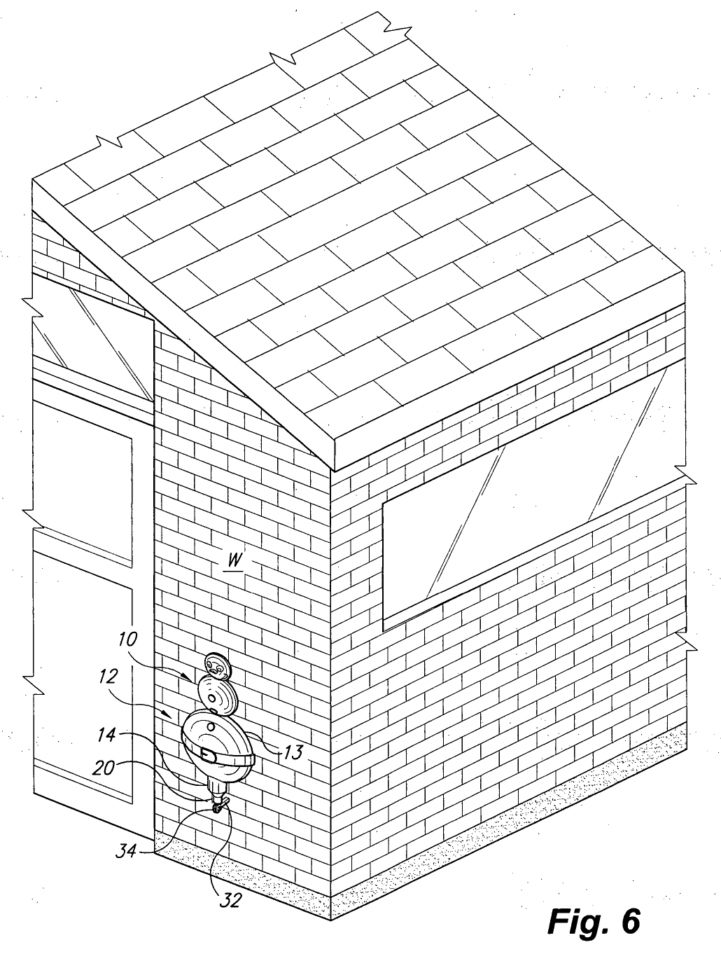

It should be understood that decorative body 12 may have any desired contour, size or representation. Further, body 12 may, alternatively, provide only a partial representation of an ornamental figure. In the embodiment illustrated in FIG. 6, decorative body 12 is a shell or demi-figurine shaped to represent a snowman. It should be understood that this representation is for exemplary purposes only. Rather than providing a full snowman, which may be viewed from any direction and seen as having a snowman representation, the decorative body 12 has a substantially flat, open rear surface 13 for placement against a wall W or other suitable support surface. For floodlights positioned on wall W, a full snowman body would not have adequate space for positioning above the floodlight. Further, by providing a partial shell forming body 12, the materials forming body 12 are conserved. Additionally, body 12 is of a lighter weight in this embodiment, thus improving portability of body 12, in addition to being more space efficient.

In the embodiment of FIG. 6, the cylindrical support sleeve 14 of the embodiment of FIG. 4 is also formed into a substantially semicylindrical support to press flush against the wall. Support 14 is formed integrally with the lower end of ornament 12. In this embodiment, the angular adjustment portion 16 is not required, as the ornament is meant to be fixed against wall W, and the support sleeve-and-hood 20 is used to secure the ornament to the floodlight, as described above. The semicylindrical housing 14 is mounted directly onto the floodlight, which is supported by a post 32, mounted in the wall. Post 32 includes a tooth joint 34 for angular adjustment. The lower portion of sleeve 14 may be further secured against the wall by a spring or other suitable elastic element.

It is to be understood that the present invention is not limited to the embodiments described above, but encompasses any and all embodiments within the scope of the following claims.

I claim:

1. A floodlight-supported decorative body and mount system, the system comprising:
a decorative body, the body being translucent and adapted for transmitting light from a lamp mounted in the floodlight;
a support sleeve depending from the decorative body, the support sleeve having a flexible bellows portion adjacent the decorative body forming a sleeve angle adjustment portion; and
a substantially tubular inner support sleeve-and-hood member having an upper cylindrical portion forming an inner support sleeve, a medial conical hood portion, and a lower neck, the inner support sleeve releasably engaging the support sleeve, the neck being adapted for attachment to a housing of the floodlight with the floodlight lamp disposed in the medial conical hood portion.

2. The floodlight-supported decorative body and mount system according to claim 1, further comprising a housing collar formed from flexible material, the collar being adapted for positioning between a housing of the floodlight and said neck of said inner support sleeve-and-hood member.

3. The floodlight-supported decorative body and mount system according to claim 1, wherein said sleeve angle adjustment portion has sufficient flexibility to be bent to a desired angle relative to vertical and sufficient rigidity to erectly support said decorative body in a vertical position.

4. The floodlight-supported decorative body and mount system according to claim 3, wherein said sleeve angle adjustment portion is adjustable 360°.

5. The floodlight-supported decorative body and mount system according to claim 1, wherein said support sleeve has a threaded inner surface and the upper cylindrical portion of said inner support sleeve-and-hood member is externally threaded to releasably engage the threaded inner surface of the support sleeve.

6. The floodlight-supported decorative body and mount system according to claim 1, wherein a sidewall of said conical hood portion has an opening formed therethrough adapted for receiving the floodlight lamp, the opening being further adapted for passage of ventilating air therethrough.

7. The floodlight-supported decorative body and mount system according to claim 1, wherein said lower neck extends in a substantially longitudinal direction, a sidewall of said neck having a size adjustment slot formed therethrough.

8. The floodlight-supported decorative body and mount system according to claim 7, further comprising an adjustable band mounted on an exterior surface of said neck, said adjustable band being adapted for releasably and adjustably securing said neck about the floodlight lamp.

9. The floodlight-supported decorative body and mount system according to claim 1, wherein said decorative body comprises a shell having a decorative front surface and a flat, open rear adapted for positioning against a planar support surface.

10. The floodlight-supported decorative body and mount system according to claim 7, further comprising:
a pair of tabs, each of the tabs being mounted on an exterior surface of said neck and disposed adjacent a respective opposed edge of the size adjustment slot; and
means for adjustably and releasably securing said pair of tabs together.

11. A floodlight-supported decorative body and mount system, the system comprising:
a decorative body, the body being translucent and adapted for transmitting light from a lamp mounted in the floodlight;
a support sleeve depending from the decorative body; and
a substantially tubular inner support sleeve-and-hood member having an upper cylindrical portion forming an inner support sleeve, a medial conical hood portion, and a lower neck, the inner support sleeve releasably engaging the support sleeve, the neck being adapted for attachment to a housing of the floodlight with the floodlight lamp disposed in the medial conical hood portion.

12. The floodlight-supported decorative body and mount system according to claim 11, wherein said decorative body comprises a shell having an open back adapted for mounting against a wall.

13. The floodlight-supported decorative body and mount system according to claim 11, wherein said support sleeve is semicylindrical.

14. The floodlight-supported decorative body and mount system according to claim 11, further comprising a housing collar formed from flexible material, the collar being adapted for positioning between a housing of the floodlight and said neck of said inner support sleeve-and-hood member.

15. The floodlight-supported decorative body and mount system according to claim 11, wherein a sidewall of said conical hood portion has an opening formed therethrough adapted for receiving the floodlight lamp, the opening being further adapted for passage of ventilating air therethrough.

16. The floodlight-supported decorative body and mount system according to claim 11, wherein said lower neck extends in a substantially longitudinal direction, a sidewall of said neck having a size adjustment slot formed therethrough.

17. The floodlight-supported decorative body and mount system according to claim 16, further comprising an adjustable band mounted on an exterior surface of said neck, said adjustable band being adapted for releasably and adjustably securing said neck about the floodlight lamp.

18. The floodlight-supported decorative body and mount system according to claim 16, further comprising a pair of tabs extending from opposite sides of said slot and a releasable fastener extending through the tabs for adjustably tightening the neck around the housing of the floodlight.
